(19) United States
(12) Patent Application Publication
(10) Pub. No.: US 2006/0026069 A1
(43) Pub. Date: Feb. 2, 2006

(54) Methods and apparatus to implement enhanced employment technology frameworks

(76) Inventors: Larry Mazurkiewicz, Elgin, IL (US); Kevin Harrison, Palatine, IL (US); Kalpesh Patel, Chicago, IL (US); Frank Pirri, Deerfield, IL (US); Wojciech Wietecha, Bartlett, IL (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/139,058

(22) Filed: May 27, 2005

Related U.S. Application Data
(60) Provisional application No. 60/574,874, filed on May 27, 2004.

(51) Int. Cl. G07G 1/14

(52) U.S. Cl. 705/14

(57) ABSTRACT

Methods and apparatus to implement enhanced employment technology frameworks are disclosed. In one example, a method of selecting media to be used for advertising an employment opportunity includes receiving from a user information representative of the employment opportunity; accessing information representing historical effectiveness of advertisements, wherein the information representing the historical effectiveness of advertisements tracks advertising transactions that were previously performed to fill an historic employment opportunity and the effectiveness of the advertising transactions in generating responses from candidates who fit the historic employment opportunity; comparing the historical effectiveness of advertisements and the information representative of the employment opportunity; and selecting a media having the historical effectiveness for the historic employment opportunity and presenting a user with an indication of the historical effectiveness of the selected media along with alternative media selections.

### CROSS-REFERENCE TO RELATED APPLICATIONS

This patent application claims the benefit of a United States Provisional patent application filed on May 27, 2004, and assigned 60/574,874, the entire content of which is incorporated herein by reference.

### TECHNICAL FIELD

The present disclosure pertains to human resources and, more particularly, to methods and apparatus to implement enhanced employment technology frameworks.

### BACKGROUND

As shown in FIG. 1, a conventional candidate recruiting system 100 includes a business or employer 102 having an employment opportunity (i.e., a job position that needs to be filled with a new hire), the availability of which is posted to an advertising media 104, such as print or Internet-based media. The posting is typically widely viewed by a number of different job seekers 106. As will be readily appreciated, the job seekers 106 range from those who are very serious in pursuing the opportunity to those who may be testing their marketability. Furthermore, the job seekers 106 possess a wide range of qualifications relative to the employment opportunity. For example, some job seekers may be highly qualified for the employment opportunity, while others may be drastically under qualified for the employment opportunity.

The job seekers 106 are prompted by the advertising media 104 to provide their resumes in response to the posting. Unfortunately for the employer 102 who has the employment opportunity, this potentially results in the employer 102 receiving a large number of resumes from candidates who range from the perfect candidate to candidates who are not at all suited to the employment opportunity. In this arrangement, the employer is forced to sort through all of the responses to find the few candidates that should be reviewed more closely and, potentially, personally interviewed.

As will be readily appreciated, the employer's strengths typically do not lie in sorting though numerous responses to job postings. Rather, the employer 102 generates revenue by pursuing his/her core business and he/she merely needs more help in pursuing the core business, hence the job posting. The employer 102 is not highly skilled at sorting through resumes to determine the ideal candidate for the opportunity and, therefore, the hiring process may be unduly burdensome on the employer 102.

To relieve the burden and to allow the employer 102 to focus on his/her core business, many employers utilize a human resources (HR) department, which adds to the operational overhead of the business because HR is not typically considered to be a profit center. Some employers turn to employment agencies, or “head hunters,” who charge placement fees to employers for each candidate hired.

### BRIEF DESCRIPTION OF THE DRAWINGS

FIG. 1 is a diagram of a known candidate recruiting system.

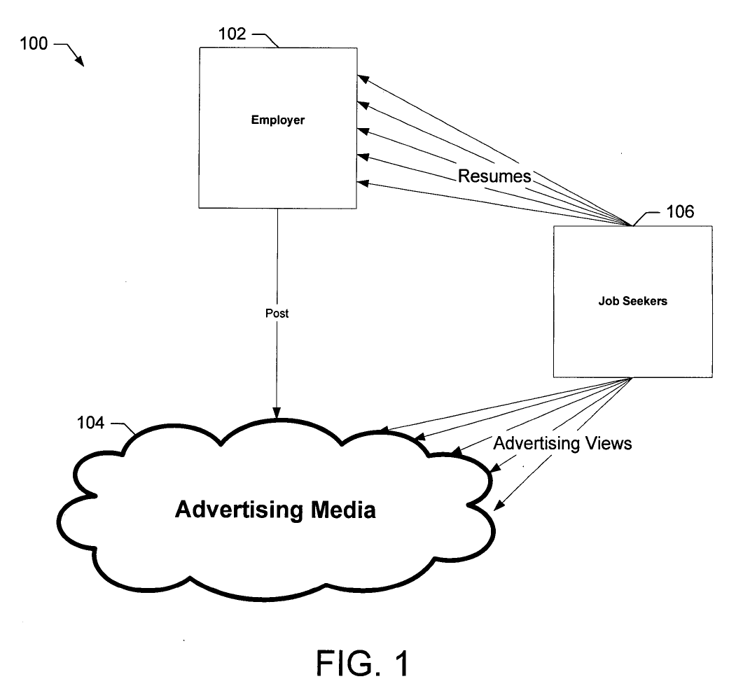

FIG. 2 is a diagram of a disclosed candidate recruiting system including an employment technology framework.

FIG. 3 is a diagram showing one example implementation of the employment technology framework of FIG. 2.

FIG. 4 is a diagram showing one example implementation of the campaign planner of FIG. 3.

FIG. 5 is a diagram showing one example implementation of the finance manager of FIG. 3.

FIG. 6 is a diagram showing one example implementation of the organization planner of FIG. 3.

FIG. 7 is a diagram showing one example implementation of the application builder of FIG. 3.

FIG. 8 is a diagram showing one example implementation of the advertising posting engine of FIG. 3.

FIG. 9 is a diagram showing one example implementation of the applicant profile collector of FIG. 3.

FIG. 10 is a diagram showing one example implementation of the display application process of FIG. 9.

FIG. 11 is a diagram showing one example implementation of the assessment tool of FIG. 3.

FIG. 12 is a diagram showing one example implementation of the skill based scoring engine of FIG. 3.

FIG. 13 is a diagram showing one example implementation of the workforce builder of FIG. 3.

FIG. 14 is a diagram showing one example implementation of the workforce analyzer of FIG. 3.

FIG. 15 is a diagram showing one example implementation of the campaign analysis engine of FIG. 3.

FIG. 16 is a block diagram of an example processor system on which the employment technology framework may be implemented.

### DETAILED DESCRIPTION

The following discloses example systems in block diagram form for ease of explanation. It will be readily appreciated that such systems could be implemented by software executed by hardware, such as a computer or a server. Additionally, certain blocks of the disclosed systems could be executed in dedicated hardware. Accordingly, while the following describes example systems, persons of ordinary skill in the art will readily appreciate that the examples are not the only way to implement such systems.

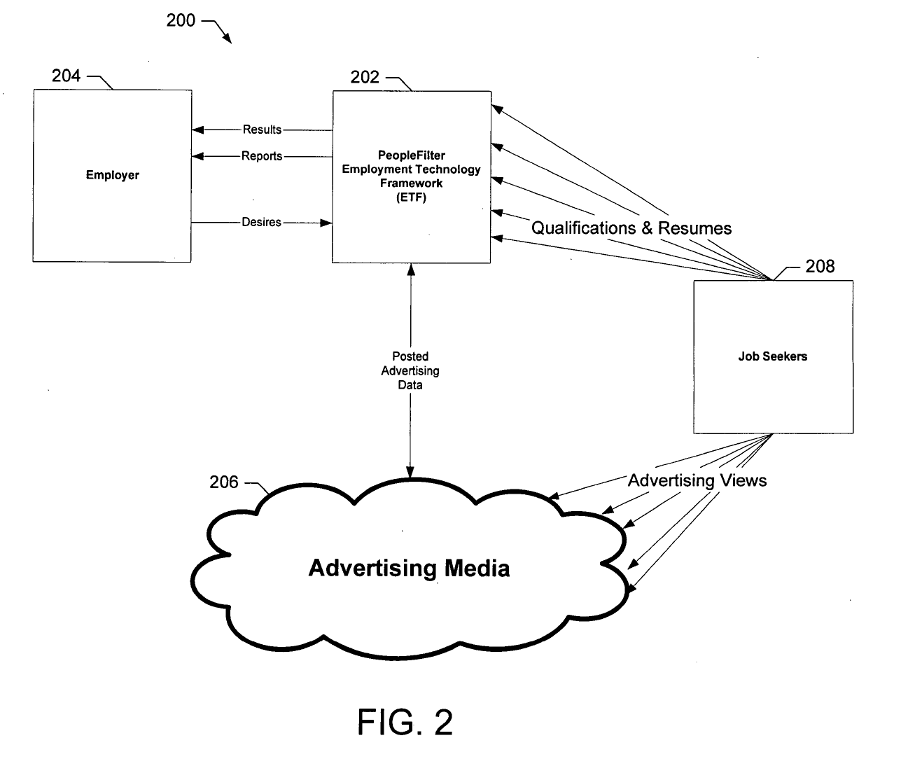

Turning now to FIG. 2, an enhanced candidate recruiting system 200 includes an employment technology framework (ETF) 202 that receives desires from employers 204 who have employment opportunities. The ETF 202 coordinates the posting of employment opportunities or desires to advertising media 206. The advertising media 206 is viewed by job seekers 208 (also referred to herein as potential employees, candidates, and/or applicants) who respond to the ETF 202, rather than responding directly to the employer 204 having the employment opportunity. In general, the ETF 202 receives qualifications and resumes from the job seekers 208 and, as described below, processes these qualifications and resumes to rank candidates and provide results to the employer 204 with the employment opportunity. Additionally, as described below, the ETF 202 provides reports to the employer 204 so that the employer 204 can asses the effectiveness (both in quantity and quality) of the qualifications and resumes received in response to the selected advertising media.

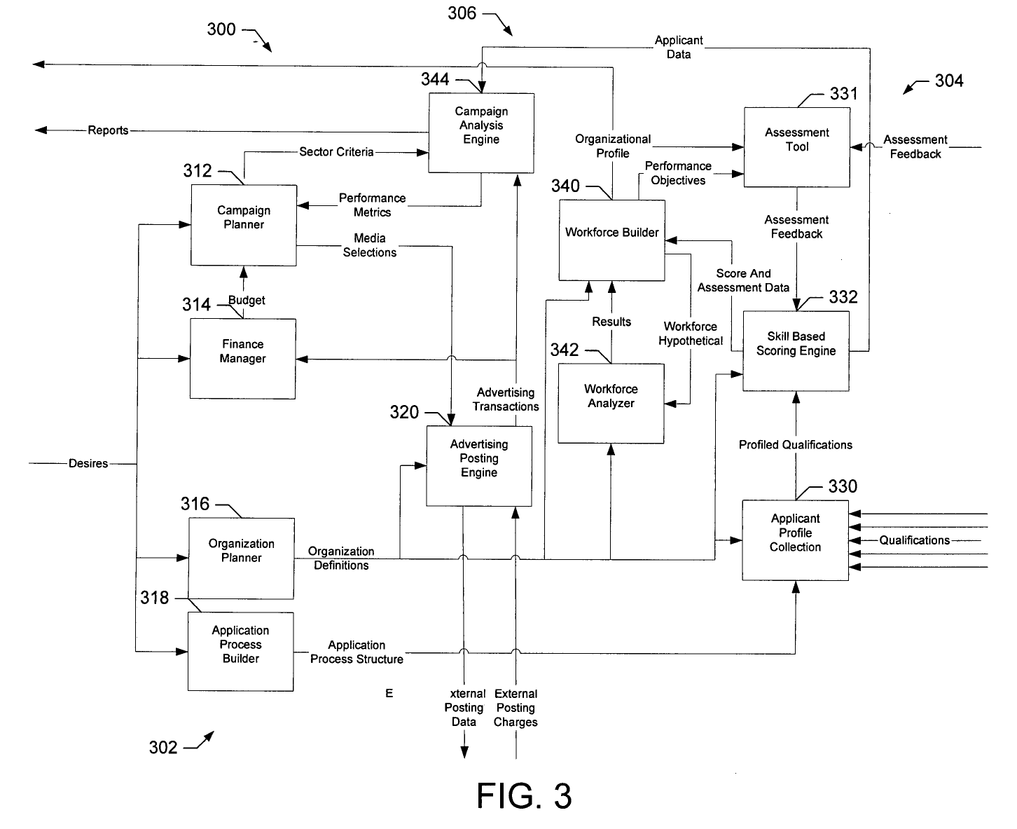

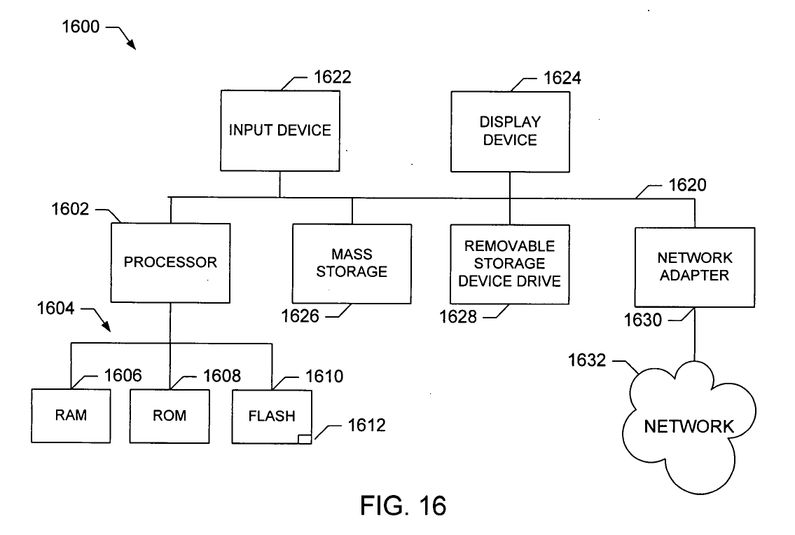

As described below in detail, the ETF 202 is a tool or set of tools that may be used to shield employers, such as the employer 204, from posting job ads and wading through the responses to such ads. By protecting employers from ad placement and ad response activities, the ETF 202 enables employers to focus on their core business. The ETF 202 is described in conjunction with FIGS. 3-15, it being understood that the full range of functionalities shown and described in conjunction with these figures need not be implemented to form an effective ETF 202. In one particular, implementation, the ETF 202 may be implemented as software executed by hardware, such as a personal computer or a server, which is described in conjunction with FIG. 16.

The employer 204 may have one or many employment opportunities that may be any job opening (such as a full-time salaried position, a part-time position, and a seasonal or temporary position). The employer 204 defines the employment opportunity in terms of desires, which delineate the necessary and desirable attributes for candidates seeking the employment opportunity. For example, as described in detail below, the desires may be specified in terms of a number of years of experience, particular skill sets or proficiencies, and/or other desirable attributes. Although, for purposes of explanation, only one employer 204 is shown in FIG. 2, it will be readily appreciated by those having ordinary skill in the art that more than one employment opportunity may be processed by the ETF 202.

The ETF 202 is adapted to operate with any suitable advertising media 206. The advertising media 206 may be implemented by any medium or media. For example, the advertising media 206 may be implemented using electronic media, such as electronic mail, Internet-based postings such as job boards, or other web pages. Alternatively or additionally, the advertising media 206 may be any print media such as advertisements in newspapers, trade magazines, or any other print media.

As will be readily appreciated, the job seekers 208 will likely have a wide range of qualifications and seriousness regarding the employment opportunity. For example, some candidates may be very serious about the opportunity, but be under qualified, whereas other candidates may be highly qualified, but only passively interested in the employment opportunity 204. The power of the ETF 202 is that the employer 204 is protected from having to review all the qualifications and resumes provided by all the job seekers 208. The ETF 202 allows the employer 204 to view only the serious and most qualified candidates first. Additionally, the ETF 202 enables the employer to customize the manner in which the resumes and qualifications are provided by the job seekers 208. For example, through the use of the ETF 202, the employer 204 may specify groups of questions or individual questions that the job seekers must answer 208 before their resumes and qualifications are accepted by the ETF 202.

As shown in FIG. 3, an example ETF 300, which may be used to implement the ETF 202 of FIG. 2, generally includes an employment opportunity collection side 302, a candidate collection and evaluation side 304, and an analysis side 306.

The employment opportunity collection side 302 generally includes a campaign planner 312, a finance manager 314, an organization planner 316, an application process builder 318, and an advertising posting engine 320. Employers provide information pertinent to an employment opportunity to the employment opportunity collection side 302. Such information may include organization structure information, desirable attributes, skills, and proficiencies for a particular employment opportunity. The employer, such as the employer 204 of FIG. 2, may also provide information related to budgetary constraints for filling the employment opportunity. For example, the employer may provide an expenditure allocation or cap to be used when placing ads to fill the employment opportunity. Additionally, an employer may specify the application process that the candidates for the employment opportunity are to go through to be considered for the employment opportunity. The application process may be specified in terms of application components to be included and the order that the components are presented. Examples of these components include, but are not limited to, things such as contact information, resume, education, industry experience, work history, and application questions or sets of questions that a potential employee may be required to answer regarding their skills or attributes related to the employment opportunity. Further, the employer may provide characteristics of the skills of his/her organization so that skill sets of candidates for the employment opportunity may be evaluated in light of an employer's entire organization.

Based on the information provided by the employer, the ETF 300 generates and places advertisements to solicit candidate responses to fill the employment opportunity. Among other things, the generation of advertisements may take into consideration budget allocations for different media in which the employment opportunity is to be advertised. Further, the ETF 300 may recommend advertising media based on the historical effectiveness of the media. For example, based on historical data acquired by the ETF 300, the ETF 300 may determine that, for a specific category of opportunities, one particular advertising medium yields a high number of responses, but that the responses are not of very high quality. The ETF 300 may also determine that another medium may, for example, yields fewer, but better quality responses. Based on the historical types of responses generated by media and the desires provided by the employer, the ETF 300 selects advertising media on which the advertisement for the employment opportunity may be placed. Such placement may be carried through the use of a posting engine as described below.

Once the advertisement for the employment opportunity is placed, potential employees may respond to the advertisement though the submission of resumes and/or qualifications to the candidate collection side 304, which includes an applicant profile collector 330, a skill based scoring engine 332, and an assessment tool 334. In general, the candidate collection and evaluation side 304 receives information from candidates who have expressed interest in the employment opportunity and scores and ranks candidates based on how well their provided information matches the desirable attributes provided by the employer. The submissions may be in paper or electronic form and may be scored manually or automatically. Additionally, the candidate collection side 304 may receive assessment feedback regarding candidates from persons other than the candidates. This information may be in the form of a peer review or the like.

The analysis side 306 includes a workforce builder 340, a workforce analyzer 342, and a campaign analysis engine 344. The analysis side 306 enables employers to build a model of their workforce and to evaluate the characteristics and attributes of their workforce in an iterative manner by refining the attributes of various positions in the workforce. Additionally, the analysis side 306 is aware of the advertising placed by the employment opportunity collection side 302 and the responses received at the candidate collection side 304 and, therefore, can evaluate the effectiveness of the advertisements based on the responses to the same. The effectiveness of an advertisement may be evaluated based on the number of responses to the advertisement, the quality of the responses, and/or whether any candidates responding to an advertisement medium were interviewed and/or hired.

In general, each of the employment opportunity collection side 302, the candidate collection and evaluation side 304, and the analysis side 306 are discussed below. However, because there is interaction between these various sides, there may be instances in which an item of one side is described in context with items from another side.

The campaign planner 312, the finance manager 314, the organization planner 316, and the application process builder 318 receive desires for qualifications related to an employment opportunity (e.g., an employment opportunity specified by the employer 204 of FIG. 2). The campaign planner 312 is coupled to the campaign analysis engine 344, which receives information from the advertising posting engine 320 and the skill based scoring engine 332.

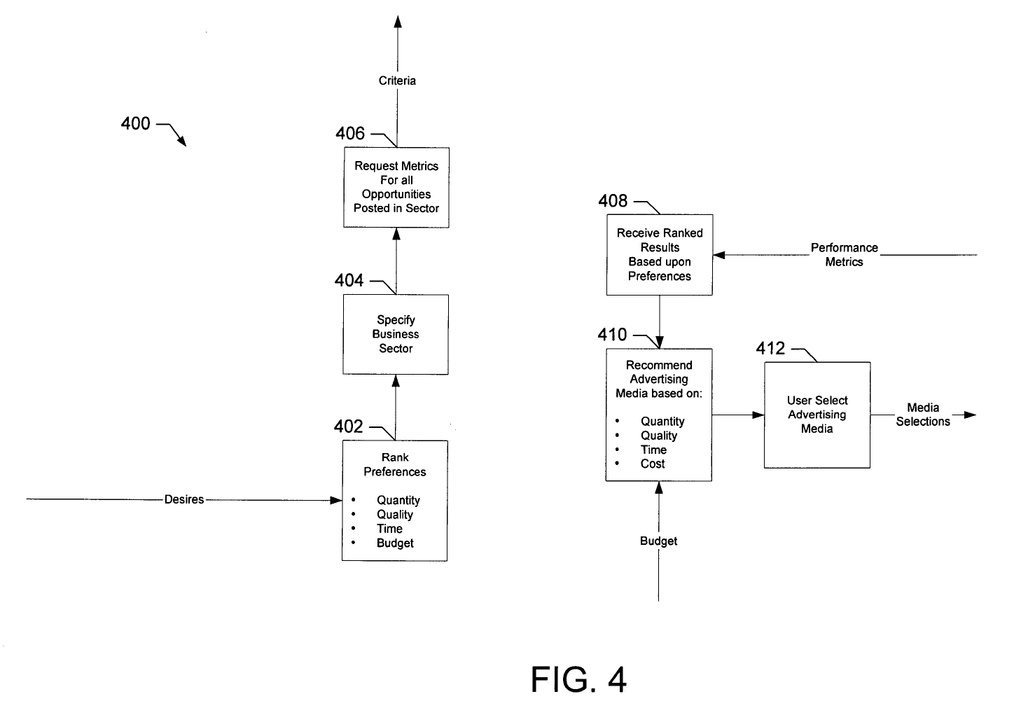

The campaign planner 312, the details of which are described in further detail below in conjunction with FIG. 4, generally plans an advertising campaign to solicit responses to fill a specified employment opportunity. In particular, the campaign planner 312 recommends media based on desires related to a particular opportunity and performance metrics representative of advertising effectiveness, which are provided by the campaign analysis engine 344.

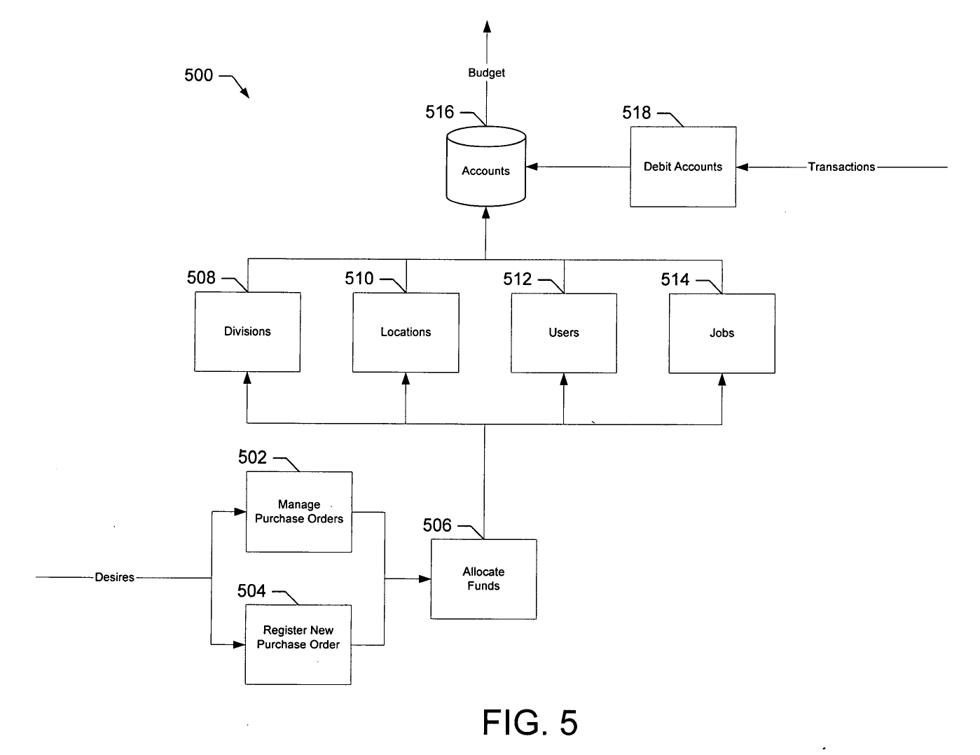

The finance manager 314, which is described in further detail in conjunction with FIG. 5, receives desires related to money to be allocated to filling employment opportunities. The finance manager 314 may allocate funding in a number of different ways that affect funding spent on advertising for any employment opportunity. For example, the finance manager 314 may allocate a block of funds across various employment opportunities based on business divisions, geographical locations, users, and/or jobs to be performed. Based on this information, funding is allocated to advertising a particular employment opportunity. The funding is communicated from the finance manager 314 to the campaign planner 312, so that the campaign planner 312 knows the expenditure limit for a particular employment opportunity and can allocate those funds accordingly.

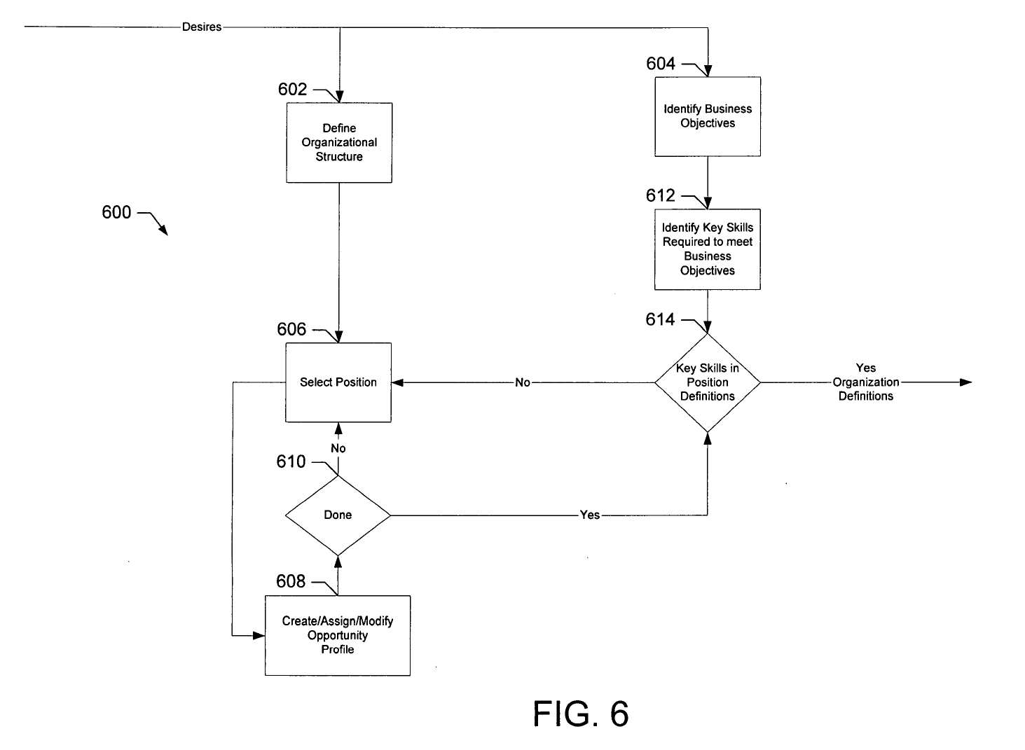

The organization planner 316, which is described in conjunction with FIG. 6, processes user desires related to the organizational model of the business for which the employment opportunity is being posted. For example, a user may interact with the organizational planner 316 to interactively form, revise, or otherwise define organizational specifications related to employment opportunities. As described below in detail in conjunction with FIG. 6, the organizational planner 316 may be used to create an overall organizational chart including a number of positions, each of which is defined by various criteria, thereby enabling analysis related to hiring for various positions within the organization. The output of the organization planner 316 is an organization definition that may include specifications related to an organizational structure and the desired characteristics for each position within the organizational structure.

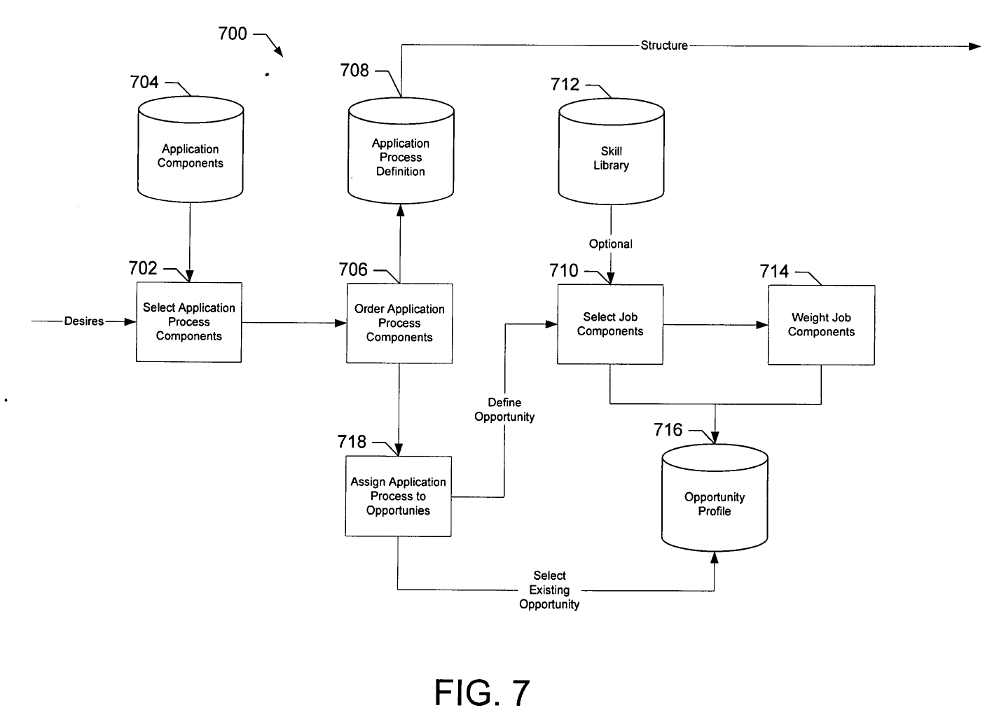

The application process builder 318, which is described below in conjunction with FIG. 7, enables an employer to specify the job application process that potential candidates must complete to be considered for a particular position. The application process may be defined based on individual opportunities, classes of opportunities, organizational characteristics, and/or any other criteria.

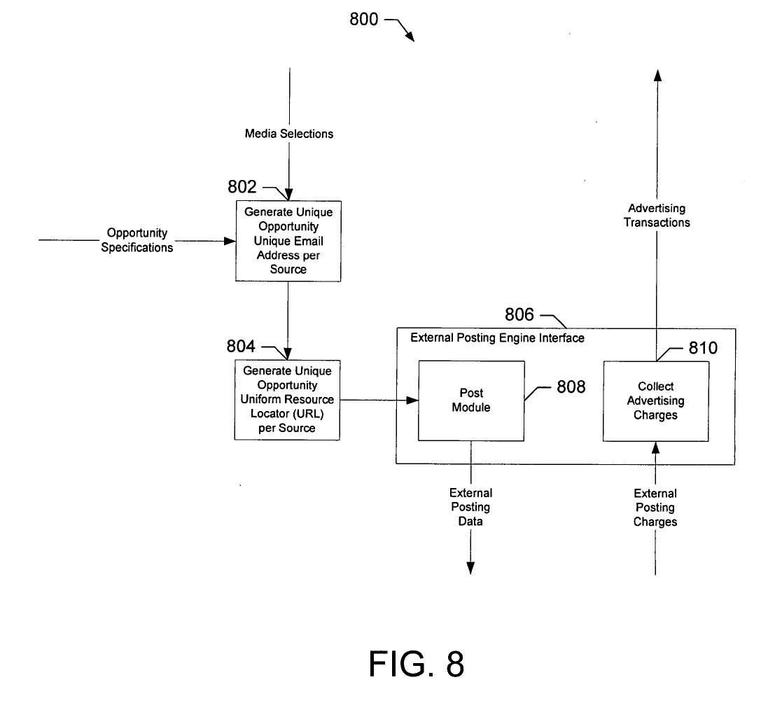

The advertising posting engine 320, described in connection with FIG. 8 below, receives media selections from the campaign planner 312, as well as the organization definitions from the organization planner 316 and produces external posting data representative of advertisements that are directed to advertising media, such as print or electronic media. The advertising posting engine 320 receives external posting charges, which result from the advertisements placed by the external posting data. The advertising posting engine 320 provides a list of advertising transactions to the campaign analysis engine 344, so that the campaign analysis engine 344 may analyze the effectiveness of the advertising when responses to the advertising are received at a later point in time.

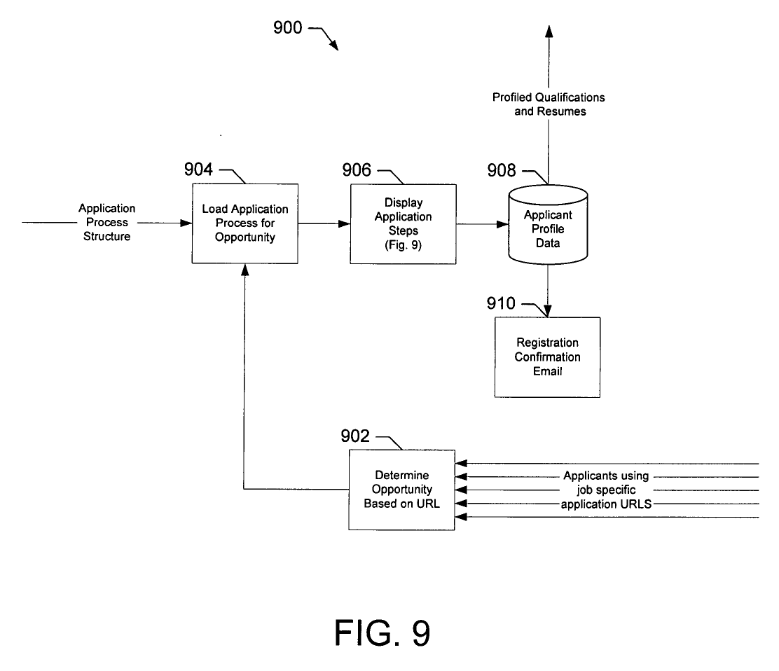

The applicant profile collector 330, which is described in conjunction with FIG. 9 below, is the interface through which potential candidates for the employment opportunity submit their qualifications. For example, the applicant profile collector 330 may present to a candidate an Internet-based questionnaire or sequence of questions specified by the application process builder 318 and the opportunity specifications provided as part of the organization definitions from the organization planner 316, both of which are based on the desires supplied by the employer.

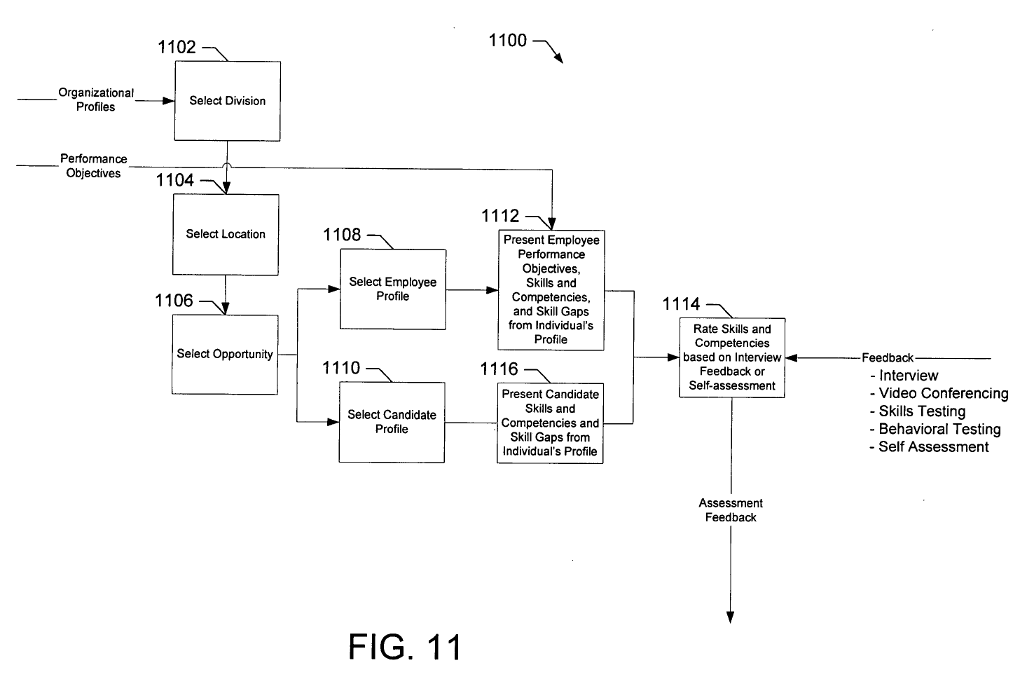

The assessment tool 331, which is described in conjunction with FIG. 11, receives assessment feedback that may be in the form of peer review feedback, candidate interview information, skills or behavioral testing, etc. The interview information and review feedback is used to rate a particular candidate in various areas of skills or competencies, thereby resulting in additional criteria that is provided to the skill based scoring engine 332.

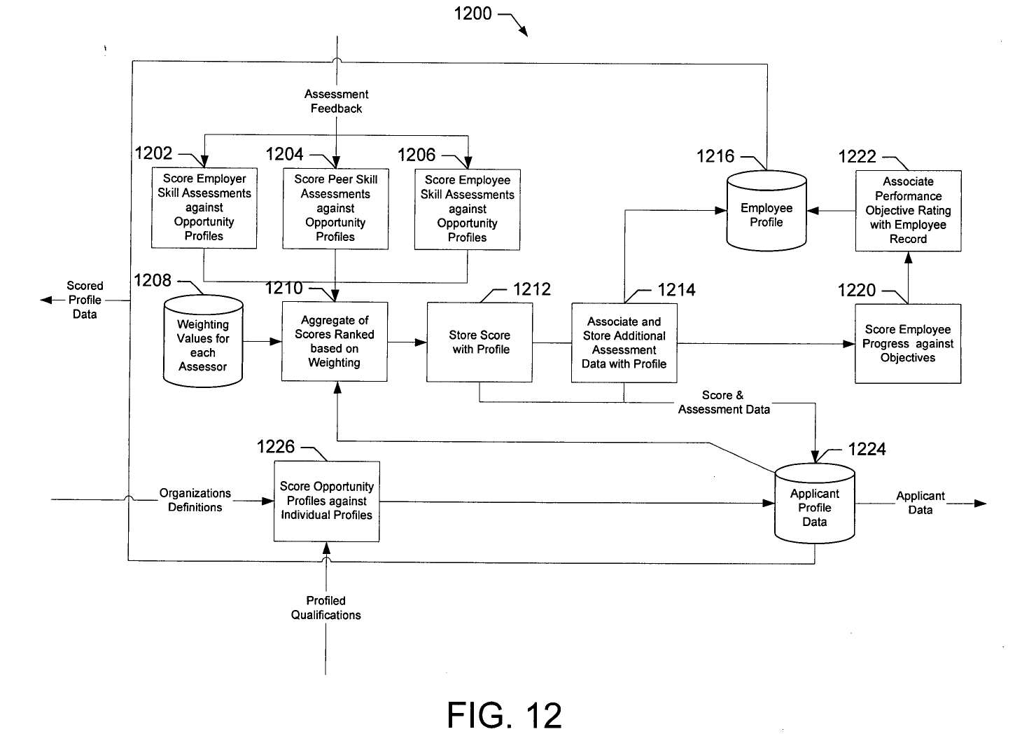

The skill based scoring engine 332, described in conjunction with FIG. 12 below, compares profiled qualifications, which are received from the applicant profile collector 330, to the opportunity specifications from the organization planner 316. The results are individual scores for each candidate for the employment opportunity. The scores may be represented by a single numerical score or may be represented by combinations of numerical scores, each representing a different aspect or perspective of the candidate's qualifications for the employment opportunity. The results of the scoring are provided to the workforce builder 340 (so that the overall capabilities of the workforce including the potential candidate may be analyzed). Candidate data and information collected by the skill based scoring engine 332 is also provided to the campaign analysis engine 344 so that the information and data can be used to evaluate the effectiveness of advertising campaigns.

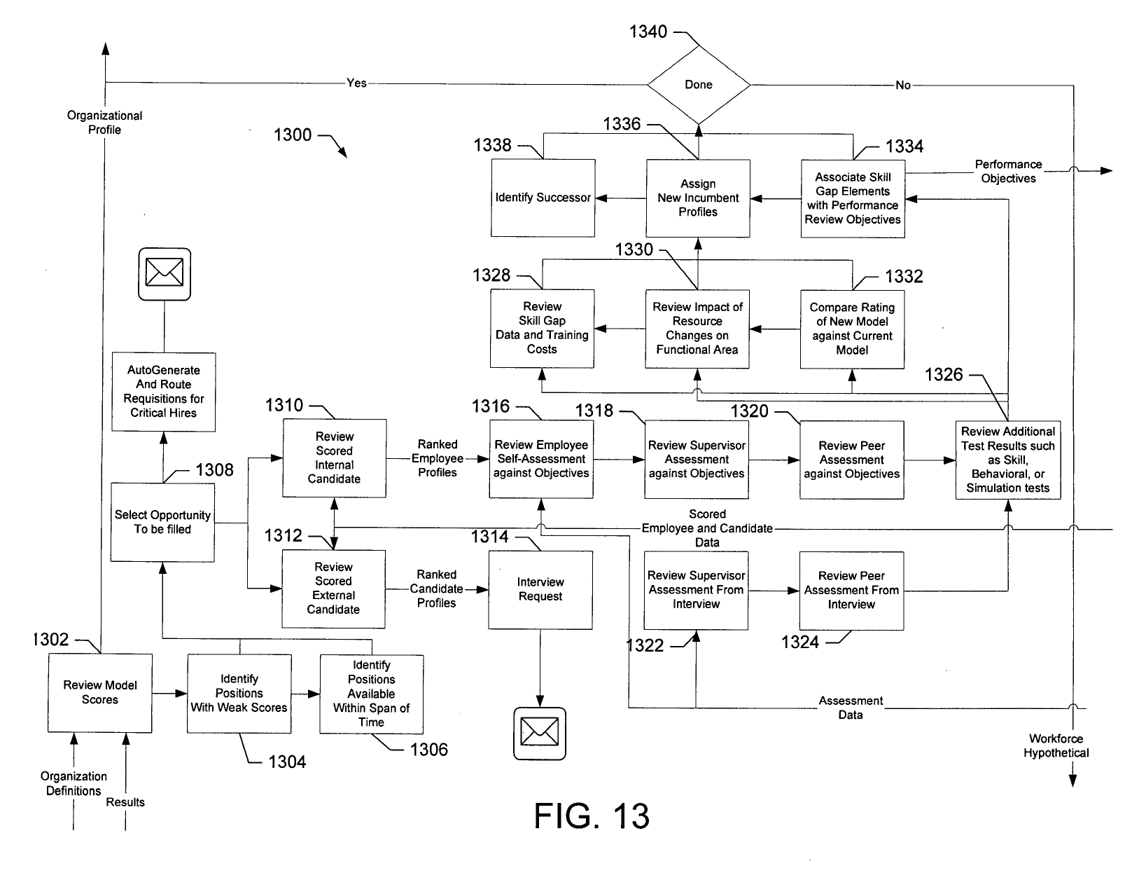

The workforce builder 340, which is described below in conjunction with FIG. 13, enables employers to populate the organization structure defined by the organization planner 316 with current employees or candidates. Once the organizational structure is populated with employees or candidates, the information is passed to the workforce analyzer 342 as a workforce hypothetical.

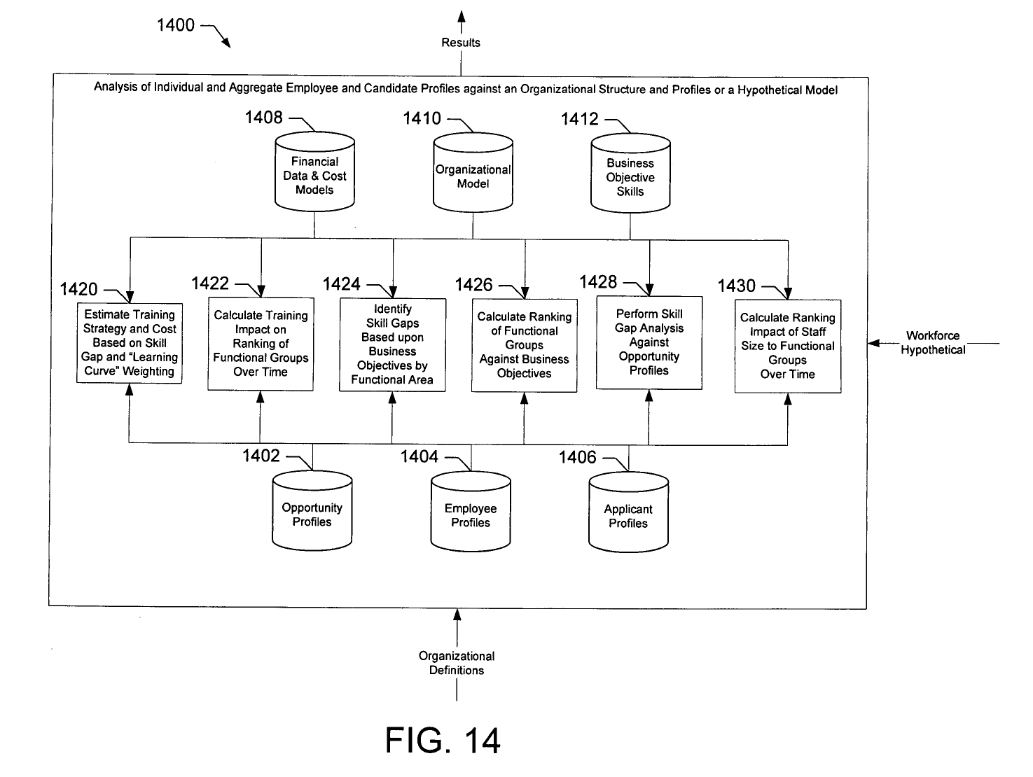

As described below in conjunction with FIG. 14, the workforce analyzer 342 processes individual and aggregate employee and candidate profiles against an organization structure, which was defined by the employer in the organization planner 316. The results generated by the workforce analyzer 342 represent how well the employees and candidates used to populate the organizational structure meet the organizational definitions.

As noted earlier, the campaign analysis engine 344 produces performance metrics indicative of the effectiveness, both in terms of quantity and quality, of advertising campaigns to fill a particular employment opportunity. To analyze the effectiveness of a campaign, the campaign analysis engine 344 tracks criteria generated by the campaign planner 312, the advertising transactions that were actually implemented, which is provided by the advertising posting engine 320, and candidate scores (i.e., measures of how well each candidate fit the employment opportunity as defined by the desires) provided by the skill based scoring engine 332.

Turning now to FIG. 4 an example campaign planner 400, which may be used to implement the campaign planner 312 of FIG. 3, obtains preferences from an employer 402. The preferences may include information related to quantity (i.e., the number of responses desired), quality (i.e., the score of the responses that are received), time (i.e., the speed at which the responses are generated or the time by which the employment opportunity is to be filled), and budget, which is the amount of money to be spent to fill the employment opportunity. The campaign planner 400 also requests the employer to specify a business sector in which the employment opportunity lies (block 404) and requests metrics for all employment opportunities posted in the business sector (406). Together, the ranked preferences, the specified business sector, and the requested metrics form criteria that are passed to the campaign analysis engine.

The campaign planner 400 receives performance metrics from a campaign analysis engine, which amount to ranked results based upon employer preferences (block 408). The performance metrics are historical measures of advertising effectiveness that are broken down by quantity of responses, the quality of responses, the time to fill a particular employment opportunity, and the cost of placing the ads.

Based on the performance metrics (i.e., the historic effectiveness of advertising media) and the rank preferences provided by the employer (block 402), the campaign planner 400 makes an advertising recommendation (block 410). The advertising recommendations are presented to the employer along with alternative advertising media that may be selected. As shown in FIG. 4, the advertising recommendations (block 410) are also based on budgetary constraints that may be provided by a finance manager. The employer selects advertising media based on the recommendation and based on the available media (block 412). This results in media selections that are generated by the campaign planner 400 and provided to an advertising posting engine, such as the advertising posting engine 320 of FIG. 3.

As shown in FIG. 5, a finance manager 500 receives employer desires relevant to managing purchase orders (block 502) and registering new purchase orders (block 504). The management of purchase orders and the registration of new purchase orders allow the finance manager 500 to determine how much funding may be allocated across several employment opportunities, which may be broken down a number of different ways as described below. After the total funding that is available is determined based on purchase order management (block 502) and registration of new purchase orders (block 504), the employer allocates the available funds (block 506). As will be readily appreciated by those having ordinary skill in the art, the funds for advertising may be allocated in any number of different ways. For example, as shown in FIG. 5, the finance manager 500 may prompt an employer to allocate funds across various divisions of an organization (block 508), organizational locations (block 510), various users (block 512), and various jobs or employment opportunities (block 514).

Divisional allocation (block 508) may include allocating funding for all employment opportunities within various divisions of an organization. Location allocation (block 510) may include funding allocations across geographical locations of a number of branches of an organization. Allocating funds on a per user basis (block 512) may be used to allocate funding across a number of managers or professionals seeking to fill employment opportunities within a particular organization. Funding allocations across jobs (block 514) enables funding allocation across a number of employment opportunities.

After the funding allocation is made, accounts may be stored in a database 516 for each allocation, thereby setting a budget for each employment opportunity, which may be fed to a campaign planner, such as the campaign planner 312 of FIG. 3. As the finance manager 500 receives status regarding advertising transactions that have transpired, the cost associated with these transactions are debited from the accounts to which the advertising is allocated (block 518). Accordingly, the finance manager 500 assists employers in budget allocation, administration, and tracking.

As shown in FIG. 6, an organization planner 600, which may be used to implement the organization planner 316 of FIG. 3, generally receives desires from employers and generates organizational definitions based thereon. Upon accessing the organization planner 600, the employer will be able to define an organizational structure (block 602), which may be graphically represented as an organization chart. The employer may also identify business objectives (block 604) that will be applied to the defined organizational structure.

After the organizational structure is defined (block 602), a position within the organizational structure is selected for further definition (block 606). The employer is then prompted to create, assign, or modify an opportunity profile for the selected position (block 608) to define desirable attributes of that position. If there are more positions to be defined or modified (block 610), the employer may select another position (block 606). Alternatively, if there are no more positions that the employer desires to modify (block 610), the organization planner 600 compares key skills produced as a result of business objective analysis (block 612) to the opportunity profiles defined for each position (block 614). If the key skills in the opportunity profile match or exceed the key skills required to meet the defined business objectives (block 614), organization definitions are output from the organization planner 600. Alternatively, if there is a skills gap (block 614), the employer is prompted to modify opportunity profiles for various positions (block 608) until the skills gap is eliminated (block 614).

Further detail regarding an application builder 700 is provided in conjunction with FIG. 7. The application builder 700 of FIG. 7 may be used to implement the application process builder 318 of FIG. 3. In general the application builder 700 enables an employer to customize the application process the candidates follow as they apply for such employment opportunities. For example, turning to FIG. 7, the employer first selects application process components (block 702) from an application process component database (block 704). As will be readily appreciated by those having ordinary skill in the art, application process components that may be selected from the applications components database 704 may include, among other things, contact information, electronic resume data, education, industry experience, skills, application questions, and EEO questions. After the selection of the process components (block 702), the employer is prompted to arrange the selected application process components in the order in which the employer would like them presented to candidates for the employment opportunity (block 706). After the application process components have been arranged in a particularly desirable order (block 706), an application process definition is formed and stored in an application process definition database 708, which provides structure to an applicant profile-collector, such as the applicant profile collector 330 of FIG. 3. After the application process components have been arranged in a desirable order (block 706), the employer may elect at this time to associate the application process with one or more opportunities (block 718), such groupings may be based on different criteria such as, for example, job type or industry sector. If the employer desires, the application process may be associated with a new opportunity. At this point, the employer is prompted to specify attributes of the selected job components (block 710) such as educational degree level achieved and field of study, specific industry experience, or specific skills and competencies (block 712). The new job specification data is stored in an opportunity profile database (block 716) along with a reference to the assigned application process. After the job components have been selected (block 710), the employer is prompted to weight the job components 714 to establish a relative order of importance of the job components. The selected job components and/or the job component weights are provided to an opportunity profile database 716. The opportunity profile specification data becomes part of the organizational definition.

One example of an advertising posting engine 800 is shown in FIG. 8. In general, as described in conjunction with FIG. 3, the advertising posting selection receives organization definitions including employment opportunity characteristics generated by an organization planner, such as the organization planner 316 of FIG. 3, and receives media selections from a campaign planner, such as the campaign planner 312 of FIG. 3. The advertising posting engine processes the opportunity specifications and the media selections to generate a unique opportunity e-mail address for each employment opportunity (block 802). Additionally, the advertising posting engine 800 generates a unique opportunity uniform resource locator for each employment opportunity (block 804). The unique e-mail address and the unique uniform resource locator are passed to an external posting engine interface 806 including a post module 808 that generates external posting data for each employment opportunity, wherein the external posting data includes the e-mail address and the uniform resource locator associated with the employment opportunity.

Of course, in response to external posting of advertising, which is performed by the advertising posting engine 800, expenses will be incurred. Accordingly, the advertising posting engine 800 receives at the external posting engine interface 806 external posting charges and collects advertising charges (block 810) that are passed to a finance manager 314 and a campaign analysis engine so that each of these entities is aware of expenditures made on advertising.

As shown in FIG. 9, an example applicant profile collector 900, which may be used to implement the applicant profile collector 330 of FIG. 3, receives an input defining the application process structure that is driven by employer desires. The applicant profile collector 900 also receives job seeker qualifications from potential employees who are responding to the advertisements placed in the advertising media. For example, the potential employees may provide their qualifications to the applicant profile collector 900 through the use of the e-mail addresses or the job specific URLs that are included in the advertisements posted for a particular employment opportunity. The resumes that are e-mailed and/or the URLs that are accessed by potential employees are linked to the opportunity to which they correspond based on the e-mail address or the URL that the potential employee used to access the applicant profile collector 900 (block 902). In the case of an emailed resume, the applicant is sent a confirmation email that contains a copy of the URL to be used to complete an application profile for the specific opportunity. When an applicant applies through the unique URL and once the opportunity is determined (block 902), the application process for the opportunity is loaded (block 904). As noted previously, the application process structure is defined by an employer posting an employment opportunity. Accordingly, the application process for each opportunity is served up to each potential employee so that the potential employee may traverse the application process for the employment opportunity. This is represented in FIG. 9 at block 906, in which the display application process is shown.

As the potential employees traverse the application process (block 906), the applicant profile data corresponding to the potential employee is logged in a database 908 and a registration confirmation e-mail may be sent to the potential employee, at the employers direction, after the application process is complete (block 910). The profiles, qualifications, and resumes may be passed from the applicant profile data 908 to a skill-based scoring engine or any other suitable construct that will be used to evaluate potential employee provided information against qualifications specified by the employer.

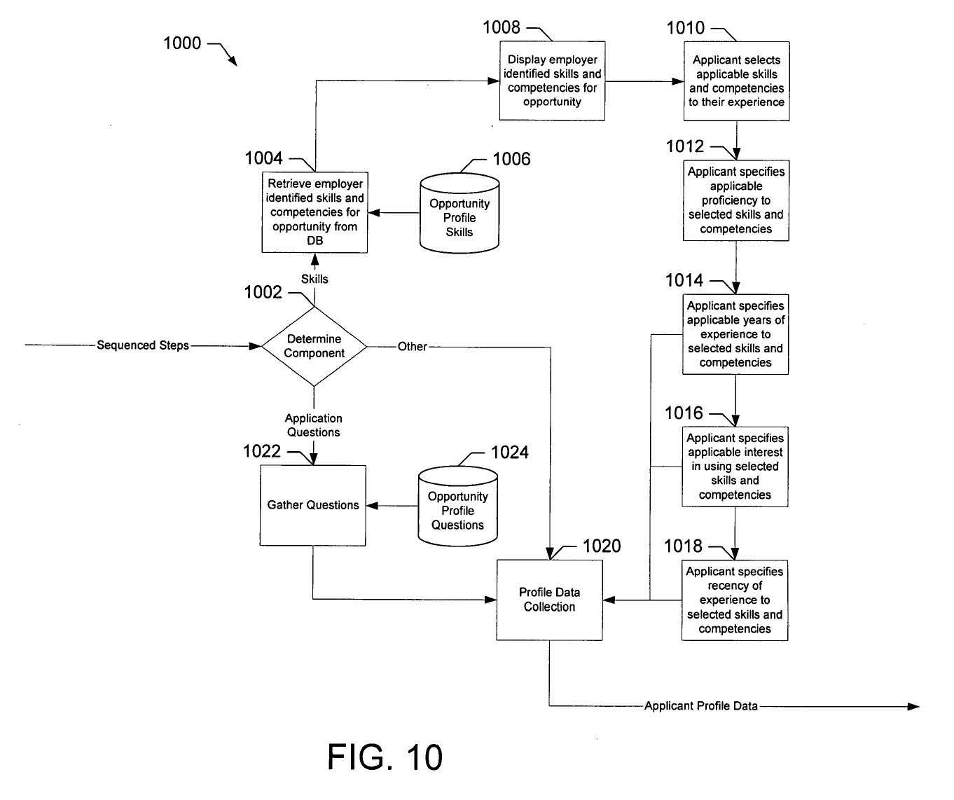

Turning now to FIG. 10, a display application process 1000, which may be used to implement the display application process 806 of FIG. 8, is shown. As shown in FIG. 10, as a potential employee traverses the process 1000, the potential employee may take a number of different paths including, but not limited to, a skills path, an application questions path, or another path. The path taken by the employee is based on the information that is being requested of the potential employee. For example, skills-based information will follow the skills path and application questions will follow the application questions path. Each of these paths will now be described.

When it is determined that the potential employee is entering the skills component (block 1002), the display application process 1000 retrieves employer identified skills and competencies for the employment opportunity (block 1004). These identified skills and competencies are stored in an opportunity profile skills database 1006. After the identified skills and competencies have been retrieved (block 1004), the skills and competencies are displayed to the potential employee (block 1008). After the employer identified skills and competencies have been displayed (block 1008), the applicant selects from the displayed skills and competencies those items meeting the potential employee's qualifications (block 1010). Further, the applicant specifies applicable proficiency in the selected skills and competencies (block 1012). Additionally, the applicant specifies the number of years of experience that the potential employee has with respect to the selected skills and competencies (1014). The potential employee may then specify applicable interest in using the skills and competencies that are specified and may specify the recency of the applicant's experience in the selected skills and competencies (1018) depending on the configuration of data to be collected for the opportunity specified by the employer. All the information gathered in blocks 1010, 1012, 1014, 1016, and 1018, is provided to the profile data collection block 1020.

With regard to the applications questions path, which is traversed when the applications question component is invoked (block 1002), the display application process 1000 gathers questions for the applicant (block 1022). These questions may be selected from the opportunity profile questions database 1024, which was populated by the employer. The results or answers to the questions that are gathered 1022 are provided to the profile data collection block 1020, as is any other information. The output of the profile data collection block 1020 is provided to a database, such as the applicant profile database 908 of FIG. 9.

The assessment tool 1100, as shown in FIG. 11, may be used to implement the assessment tool 1100 as shown in FIG. 3. In general, the assessment tool 1100 receives organizational profiles and performance objectives and presents the same to reviewers who will evaluate one or more candidates or employees with respect to the profiles or objectives. The reviewers may be supervisors, peers, or references provided by the candidate or employee. Additionally, reviewers may be the candidates or employees themselves, wherein the feedback provided is that of self-assessment. The ratings provided by the reviewer are provided to a skill based scoring engine, such as the skill based scoring engine 332 of FIG. 3.

In particular, a reviewer logs onto the assessment tool 1100 and selects a division (block 1102), a location (block 1104), and an opportunity (block 1106) that the reviewer is to evaluate. The reviewer then selects to review either a current employee (block 1108) or a candidate (block 1110). Alternatively, the user selects a specific review that is assigned to their account. If an employee is selected for review (block 1108), the reviewer is presented with the performance objectives, skills, competencies, skill gaps, etc. of the employee to be reviewed (block 1112) and the reviewer rates the employees skill and competencies (block 1114). Alternatively, if the reviewer is to review a candidate (block 1110), the reviewer is presented with candidate skills, competencies, skill gaps, etc. of the candidate (block 1116) and the reviewer then rates the candidate (block 1114).

Importantly, the feedback used by the reviewer to rank the skills and competencies of an employee or a candidate may take various formats. For example, the ranking may be done using a web-based interface, an interview, video conferencing, skills testing, behavioral testing, and/or self assessment.

An example skill based scoring engine 1200, which may be used to implement the skill-based scoring engine 332 of FIG. 3 to score employee and candidate qualifications, is shown in FIG. 12. Generally, the skill based scoring engine receives assessment feedback, profiled qualifications, and organization definitions, and processes this information to generate a scored profile for each candidate vying for the employment opportunity. In particular, as shown in FIG. 12, employer skill assessments, peer skill assessments and applicant skill assessments are scored against opportunity profiles (blocks 1202, 1204, and 1206). These scores, along with original applicant profile scores, are weighted and combined to generate an aggregate of scores ranked based on weighting (block 1210). The weighting is based on predefined criteria such as the relative influence of the assessors, which is stored in a database 1208. One example of weighting might be that a Hiring Manager assessment is worth 50% of the total score, where a peer or self assessment is worth 25%. Of course, not all of these assessments need to be made. Each candidate's score is then stored with their profile (block 1212) and any additional assessment data is associated and stored with the profile (block 1214). The employee profile is stored in an employee profile database 1216. After the additional assessment data has been associated and stored with the profile (block 1214), the employee's progress against any objectives is scored (block 1220) and a performance objective rating is associated with each employee record (block 1222) and stored in the employee profile database 1216. Alternatively, for candidates, scores are stored in an applicant profile database 1224. The skill based scoring engine 1200 also compares organization definitions to profiled qualifications from an applicant profile collector to score individual profiles against opportunity profiles (block 1226). The results of the comparison are stored in the applicant profile database 1224.

An example workforce builder 1300, which may be used to implement the workforce builder 340 of FIG. 3, is shown in FIG. 13. In general, the workforce builder 1300 enables employers to populate the organizational chart created in an organization planner (such as the organization planner 316 of FIG. 3). Once the workforce is populated into the organizational chart to create a workforce hypothetical, the workforce hypothetical is passed to a workforce analyzer (described below in conjunction with FIG. 14) for analysis.

The workforce builder 1300 enables an employer to review model scores for workforces that have been previously analyzed (block 1302) and to identify positions in the organization having weak scores (block 1304) and positions that will become available within a particular time span due to attrition, retirement, etc. (block 1306). The employer may then select an employment opportunity to be filled (block 1308) and review the score of an internal candidate (i.e., a candidate who is already employed within the organization) (block 1310) or an external candidate (i.e., a potential new hire to the organization) (block 1312). If the review of an external candidate reflects favorably on that candidate, an interview request is generated (block 1314), by e-mail or any other suitable media, to request the external candidate(s) to sign up for an interview.

Employers will use the workforce builder to maintain current profiles of employees by associating employee performance objectives with the employee profile based upon skill gap analysis or other observations of an employee's capabilities. One method of maintaining the currency of the profile data is accomplished by requiring current employees to update their profile on a regular bases and completing a self assessment of their predefined performance objectives (block 1316) as part of the employees annual review. Internal candidates are also reviewed against supervisor assessments of the candidate against candidate objectives (block 1318) and peer review of performance on the objectives (block 1320). Additionally, as shown in FIG. 13, assessment from an interview with the supervisor (block 1322) or a peer (block 1324) may also be carried out. These additional assessments may be reviewed against the objective evaluations (block 1326). A review of skill gap data (block 1328), impact of resource changes (block 1330), and ratings of prior models (block 1332) may also be carried out.

Following these assessments, skill gap elements may be associated with performance objectives (block 1334), new incumbent profiles may be assigned (block 1336), and successors may be identified by the employer (block 1338). At this point the employer may make more changes to the workforce and have the workforce hypothetical evaluated (block 1340), or may approve the workforce and its associated modified organizational profile (block 1340).

Further detail regarding one example work force analyzer 1400 is provided in conjunction with FIG. 14. The work force analyzer 1400 of FIG. 14 may be used to implement the work force analyzer 342 of FIG. 3. In general, the work force analyzer 1400 receives organization definitions and processes the definitions based on various profiles and models to develop results representative of characteristics of the work force for a particular employer. In particular, as shown in FIG. 14, the work force analyzer 1400 includes an opportunity profiles database 1402, an employee profiles database 1404, and an applicant profiles database 1406. The work force analyzer 1400 further includes a financial data and costs models database 1408, an organizational model database 1410, and a business objective skills database 1412. Each of the databases 1402, 1404, 1406, 1408, 1410, 1412 are manipulated to extract certain data therefrom. For example, the information in the databases may be used to formulate training strategy and estimate cost based on skill gap data 1420. Having an assigned value for the A-Factor Distribution (distribution of items with respect to their difficulty) of a skill or competency, and an economic multiplier associated with the cost of training, the application roughly estimates training costs and time to address deficiency of one or a group of resources. The information may also be used to calculate training impact on ranking of functional groups over time 1422. Based upon the estimated amount of time to complete training, and the scheduling of the training for one or more individuals, determine how the groups profile rank scores improve over time taking into consideration attrition and other factors. The information may also be used to identify skill gaps based upon business objectives in functional area 1424 and to calculate a ranking of functional groups against business objectives 1426. For example, if an organization has a stated objective to increase sales by 50% and the strategy to meet that objective is to hire additional sales and sales support staff, the skill requirements to meet the objectives would be defined as x number of man hours with sales and sales support skills. By modifying the organizational model to reflect the appropriate number of positions with the appropriate skills to meet the stated objective, the ability to meet the objectives becomes a factor of the number of vacancies and the skill profiles of the individuals in the filled positions. Additionally, an impact analysis of staff size to the ranking of functional groups over time may be performed 1430. The impact analysis would consider the impact to the rank of a functional group against the business objectives based on attrition or staff reductions over time. The information determined by blocks 1420, 1422, 1424, 1426, 1428, and 1430 are provided as results that are output from the work force analyzer 1400.

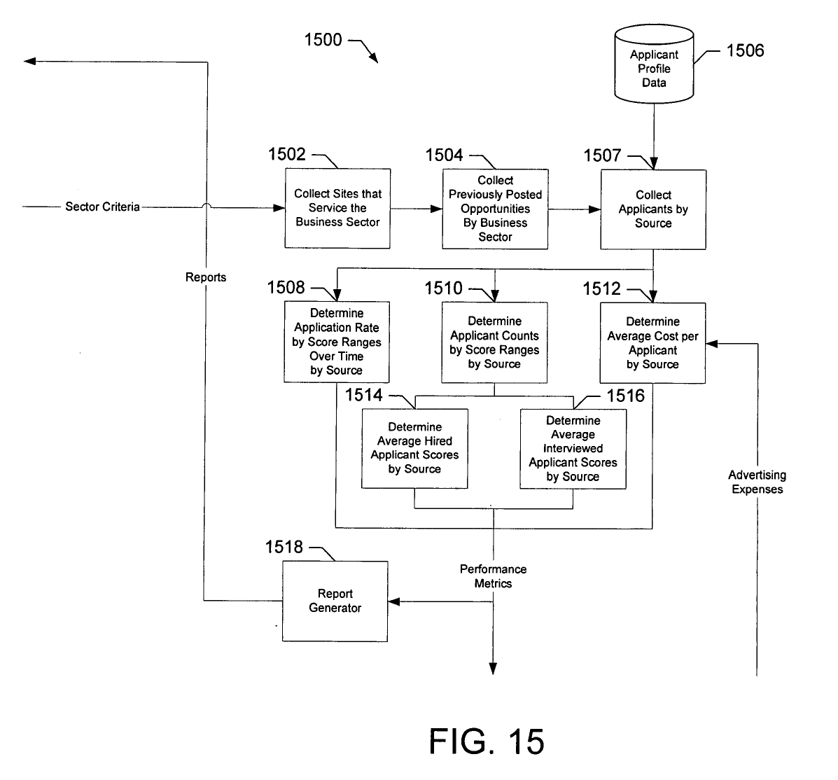

Turning now to FIG. 15, a campaign analysis engine 1500 is shown and may be used to implement the campaign analysis engine 344 of FIG. 3. In general, the campaign analysis engine 1500 compares scores produced by the skill-based scoring engine with advertising expenses to generate performance metrics and reports that are used to evaluate the effectiveness of various advertising media. To that end, the campaign analysis engine 1500 collects advertising sites that service the particular business sector being evaluated (block 1502) and collects previously posted opportunities for the business sector (block 1504). The number of applicants for an employment opportunity are then collected from an applicant profile database 1506 and delimited by the source of the applicants (block 1507). The sites that service the business sector (block 1502), the previously posted opportunities by business sector (block 1504), and applicants by source information (block 1507) are used to determine an application rate by scoring ranges over time by source metric (block 1508), determine applicant counts by score ranges by source (block 1510) and determine average cost per applicant by source (block 1512). The applicant counts by score ranges by source information (block 1510) is further manipulated to determine average hired applicant scores by source (block 1514) and average interviewed applicant scores by source (block 1516).

As shown in FIG. 15, the results of blocks 1508, 1512, 1514, and 1516 are considered performance metrics that are passed to a report generator 1518 that properly formats the performance metrics into reports that may be reviewed by the employer. Furthermore, the performance metrics may be provided to a campaign planner, such as the campaign planner 312 of FIG. 3.

While the foregoing is described in block diagram form, those having ordinary skill in the art will readily recognize that such blocks may be implemented as software or sets of instructions stored on a computer readable media, wherein a machine accesses the instructions and executes them to implement the foregoing described system. Persons of ordinary skill in the art will readily appreciate that many other methods of performing the processes and blocks described above may be used. For example, the order of many of the blocks may be altered, the operation of one or more blocks may be changed, blocks may be combined, and/or blocks may be eliminated.

As shown in FIG. 16, an example processor system 1600, includes a processor 1602 having associated memories 1604, such as a random access memory (RAM) 1606, a read only memory (ROM) 1608, and a flash memory 1610. The flash memory 1610 of the illustrated example includes a boot block 1612. The processor 1602 is coupled to an interface, such as a bus 1620 to which other components may be interfaced. In the illustrated example, the components interfaced to the bus 1620 include an input device 1622, a display device 1624, a mass storage device 1626, and a removable storage device drive 1628. The removable storage device drive 1628 may include associated removable storage media (not shown), such as magnetic or optical media. The processor system wOO may also include a network adapter 1630.

The example processor system 1600 may be, for example, a server, a remote device, a conventional desktop personal computer, a notebook computer, a workstation or any other computing device. The processor 1602 may be any type of processing unit, such as a microprocessor from the Intel® Pentium® family of microprocessors, the Intel® Itanium® family of microprocessors, and/or the Intel XScale® family of processors. The processor 1602 may include on-board analog-to-digital (A/D) and digital-to-analog (D/A) converters.

The memories 1604 that are coupled to the processor 1602 may be any suitable memory devices and may be sized to fit the storage and operational demands of the system 1600. In particular, the flash memory 1610 may be a non-volatile memory that is accessed and erased on a block-by-block basis.

The input device 1622 may implemented using a keyboard, a mouse, a touch screen, a track pad or any other device that enables a user to provide information to the processor 1602.

The display device 1624 may be, for example, a liquid crystal display (LCD) monitor, a cathode ray tube (CRT) monitor or any other suitable device that acts as an interface between the processor 1602 and a user. The display device 1624 includes any additional hardware required to interface a display screen to the processor 1602.

The mass storage device 1626 may be, for example, a conventional hard drive or any other magnetic or optical media that is readable by the processor 1602. For example, the mass storage device 1626 may store computer program code or instructions that implement the functionality described above. Accordingly, when such instructions are executed by the processor 1602, the processor coupled with the instructions performs the functions described above.

The removable storage device drive 1628 may be, for example, an optical drive, such as a compact disk-recordable (CD-R) drive, a compact disk-rewritable (CD-RW) drive, a digital versatile disk (DVD) drive, or any other optical drive. The removable storage device drive 1628 may alternatively be, for example, a magnetic media drive. If the removable storage device drive 1628 is an optical drive, the removable storage media used by the drive 1628 may be a CD-R disk, a CD-RW disk, a DVD disk, or any other suitable optical disk. On the other hand, if the removable storage device drive 48 is a magnetic media device, the removable storage media used by the drive 1628 may be, for example, a diskette or any other suitable magnetic storage media.

The network adapter 1630 may be any suitable network interface such as, for example, an Ethernet card, a wireless network card, a modem, or any other network interface suitable to connect the processor system 1600 to a network 1632. The network 1632 to which the processor system 1600 is connected may be, for example, a local area network (LAN), a wide area network (WAN), the Internet, or any other network. For example, the network could be a home network, a intranet located in a place of business, a closed network linking various locations of a business, or the Internet.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of selecting media to be used for advertising an employment opportunity, comprising:
receiving from a user information representative of the employment opportunity;
accessing information representing historical effectiveness of advertisements, wherein the information representing the historical effectiveness of advertisements tracks advertising transactions that were previously performed to fill an historic employment opportunity and the effectiveness of the advertising transactions in generating responses from candidates who fit the historic employment opportunity;
comparing the historical effectiveness of advertisements and the information representative of the employment opportunity; and
selecting a media having the historical effectiveness for the historic employment opportunity and presenting a user with an indication of the historical effectiveness of the selected media along with alternative media selections.

2. A method as defined in claim 1, further comprising receiving from the user information representing financial resources that the user has dedicated to advertising the employment opportunity.

3. A method as defined in claim 1, wherein the information representative of the employment opportunity includes at least one of information related to a quantity of responses desired, a quality of responses desired, a speed at which responses to the advertisement are generated, a time by which the employment opportunity is to be filled, or business sector in which the employment opportunity lies.

4. A method as defined by claim 1, wherein the information representing historical effectiveness includes information the quantity or quality of responses to advertisements to fill the historic employment opportunity.

5. A method as defined in claim 1, further comprising:
implementing an advertising campaign using one or more of the selected media or the alternative media selections; and
tracking the effectiveness of the advertising campaign by scoring attributes of candidates against information representative of the employment opportunity.

6. A method as defined by claim 5, wherein tracking the effectiveness of the advertising campaign further comprises tracking a number of responses received based on the advertising campaign and tracking timing of the responses received based on the advertising campaign.

7. A method as defined by claim 1, wherein the information representative of the employment opportunity includes a specified level of experience, proficiency in a skill, or years of experience.

8. An article of manufacture comprising a machine-accessible medium having a plurality of machine accessible instructions that, when executed, cause a machine to:
receive from a user information representative of the employment opportunity;
access information representing historical effectiveness of advertisements, wherein the information representing the historical effectiveness of advertisements tracks advertising transactions that were previously performed to fill an historic employment opportunity and the effectiveness of the advertising transactions in generating responses from candidates who fit the historic employment opportunity;
compare the historical effectiveness of advertisements and the information representative of the employment opportunity; and
select a media having the historical effectiveness for the historic employment opportunity and presenting a user with an indication of the historical effectiveness of the selected media along with alternative media selections.

9. A machine-accessible medium as defined by claim 8, the plurality of machine accessible instructions, when executed, cause a machine to receive from the user information representing financial resources that the user has dedicated to advertising the employment opportunity.

10. A machine-accessible medium as defined by claim 8, wherein the information representative of the employment opportunity includes at least one of information related to a quantity of responses desired, a quality of responses desired, a speed at which responses to the advertisement are generated, a time by which the employment opportunity is to be filled, or business sector in which the employment opportunity lies.

11. A machine-accessible medium as defined by claim 8, wherein the information representing historical effectiveness includes information the quantity or quality of responses to advertisements to fill the historic employment opportunity.

12. A machine-accessible medium as defined by claim 8, wherein the plurality of machine accessible instructions, when executed, cause a machine to:
implement an advertising campaign using one or more of the selected media or the alternative media selections; and
track the effectiveness of the advertising campaign by scoring attributes of candidates against information representative of the employment opportunity.

13. A machine-accessible medium as defined by claim 12, wherein tracking the effectiveness of the advertising campaign further comprises tracking a number of responses received based on the advertising campaign and tracking timing of the responses received based on the advertising campaign.

14. A machine-accessible medium as defined by claim 8, wherein the information representative of the employment opportunity includes a specified level of experience, proficiency in a skill, or years of experience.

15. An apparatus to select media to be used for advertising an employment opportunity, the apparatus comprising:
a campaign planner configured to receive from a user information representative of the employment opportunity; and
a campaign analysis engine configured to compile information representing historical effectiveness of advertisements, wherein the information representing the historical effectiveness of advertisements tracks advertising transactions that were previously performed to fill an historic employment opportunity and the effectiveness of the advertising transactions in generating responses from candidates who fit the historic employment opportunity;
wherein the campaign planner is configured to compare the historical effectiveness of advertisements compiled by the campaign analysis engine and the information representative of the employment opportunity, and wherein the campaign planner is configured to select a media having the historical effectiveness for the historic employment opportunity and to present a user with an indication of the historical effectiveness of the selected media along with alternative media selections.

16. An apparatus as defined in claim 15, further comprising a finance manager configured to receive from the user information representing financial resources that the user has dedicated to advertising the employment opportunity.

17. An apparatus as defined in claim 15, wherein the information representative of the employment opportunity includes at least one of information related to a quantity of responses desired, a quality of responses desired, a speed at which responses to the advertisement are generated, a time by which the employment opportunity is to be filled, or business sector in which the employment opportunity lies.

18. An apparatus as defined by claim 15, wherein the information representing historical effectiveness includes information the quantity or quality of responses to advertisements to fill the historic employment opportunity.

19. An apparatus as defined by claim 15, wherein the information representative of the employment opportunity includes a specified level of experience, proficiency in a skill, or years of experience.

20. A method of enabling a user to configure an application process that a candidate must follow when the candidate applies for an employment opportunity, the method comprising:
receiving an indication of selected application process components that will form the application process that the candidate must follow; receiving an indication of an order in which the selected application process component will be followed by the candidate;
storing an application definition represented the selected and ordered application process components;
receiving an indication of the employment opportunity to which the application definition corresponds; and
presenting the selected and ordered application process components to the candidate applying for the employment opportunity.

21. A method as defined by claim 20, wherein the application process components include one or more of the applicant's contact information, an electronic version of a resume, educational history, industrial experience, skills, employment application questions, live video interviews, or equal employment opportunity questions.

22. A method as defined by claim 20, wherein receiving the indication of the employment opportunity to which the application definition corresponds includes specifying a group of employment opportunities.

23. A method as defined by claim 22, wherein employment opportunities in the group of employment opportunities comprise a similar job type.

24. A method as defined by claim 22, wherein employment opportunities in the group of employment opportunities comprise a similar industry sector.

25. An article of manufacture comprising a machine-accessible medium having a plurality of machine accessible instructions that, when executed, cause a machine to:
receive an indication of selected application process components that will form the application process that the candidate must follow;
receive an indication of an order in which the selected application process component will be followed by the candidate;
store an application definition represented the selected and ordered application process components; receive an indication of the employment opportunity to which the application definition corresponds; and
present the selected and ordered application process components to the candidate applying for the employment opportunity.

26. A machine-accessible medium as defined by claim 20, wherein the application process components include one or more of the applicant's contact information, an electronic version of a resume, educational history, industrial experience, skills, employment application questions, live video interviews, or equal employment opportunity questions.

27. A machine-accessible medium as defined by claim 20, wherein receiving the indication of the employment opportunity to which the application definition corresponds includes specifying a group of employment opportunities.

28. A machine-accessible medium as defined by claim 27, wherein employment opportunities in the group of employment opportunities comprise a similar job type.

29. A machine-accessible medium as defined by claim 27, wherein employment opportunities in the group of employment opportunities comprise a similar industry sector.
